(19) United States
(12) Patent Application Publication
(10) Pub. No.: US 2023/0179578 A1
(43) Pub. Date: Jun. 8, 2023

(54) METHOD IMPLEMENTED BY AN INTERMEDIATE ENTITY FOR MANAGING COMMUNICATION BETWEEN TWO COMMUNICATION DEVICES

(71) Applicant: Orange, lssy-les-Moulineaux (FR)

(72) Inventors: Mohamed Boucadair, CHÂTILLON CEDEX (FR); Christian Jacquenet, CHÂTILLON CEDEX (FR)

(21) Appl. No.: 17/917,464

(22) PCT Filed: Apr. 8, 2021
(86) PCT No.: PCT/FR2021/050624

§ 371 Date: Oct. 6, 2022

(30) Foreign Application Priority Data
Apr. 10, 2020 (FR) FR2003621

(51) Int. Cl. H04L 9/40

(52) U.S. Cl. CPC H04L 63/0414; H04L 63/0236; H04L 63/10

(57) ABSTRACT

A method for managing communication between at least one first communication device and at least one second communication device in a communication network is implemented by an intermediate entity positioned on at least one path taken by data packets of said communication. The method includes a step of obtaining a communication identifier included in a data packet exchanged during the communication, and a step of processing the data packet depending on the result of a check of the compliance of the communication identifier with at least one communication identifier mask accessible to the intermediate entity.

### PRIOR ART

The invention relates to the general field of telecommunications. It more specifically concerns the management of communication between two communication devices (termination points of the communication) by an entity placed on at least one path of this communication.

This application does not make any assumptions as to the type of these communication devices. They may consist of terminal equipment used by the customers of a network operator, such as for example a digital decoder or Set Top Box (STB), an item of User Equipment (UE), a Personal Computer (PC), a Smartphone, a connected television or a tablet, but also by items of equipment managed by an operator of a telecommunications network (for example a server, firewall or router), these items of equipment being able to be fixed or mobile. The communication devices can also be software applications, or service instances hosted in an item of equipment.

Nor does this application make any assumptions as to the nature of the entity placed on the communication path(s). Any entity placed on the path taken by the packets exchanged between communication devices as part of their communication can implement the invention. The entity, hereinafter known as the “intermediate entity” can be integrated into one of the communication devices or not.

The invention has a preferred but non-limiting application in telecommunications networks in which the addresses (IP) of the communication devices are liable to change during a communication.

It is particularly applicable in the context of an IP network. This is because, in such a network, it is known that one or more IP addresses assigned to a terminal are liable to change during a communication, for example when the terminal is in movement, particularly in a context of handover or roaming.

Solutions for adapting to such situations, for example solutions based on the activation of protocols such as the QUIC protocol, identify a communication between two communication devices by a specific identifier (Connection IDentifier (CID) in the case of the QUIC protocol). This identifier is independent of the IP addresses and of the port numbers used by the communication devices during a given communication. This identifier will be hereinafter referred to as the “communication identifier”.

To reinforce the security of the communications and make it harder to trace them, the QUIC protocol makes it possible to vary the communication identifier during a communication, without ending said communication. More precisely, one communication device communicates to the other communication device a list of identifiers that the latter can use during the communication. In the case of the QUIC protocol (which encrypts not only the useful data but also most of the characteristic information of the communication), this list of identifiers is transmitted by one communication device to the other communication device securely, via an encryption mechanism.

It is therefore very difficult for an entity such as a firewall or a load balancer, placed on a path taken by the communications set up between the two communication devices, to be involved in the management of such communications (for example, to optimize the use of the resources employed during the time the communication lasts) or to apply deterministic processing to the characteristic features of these communications (such processing is, for example, the selection of one and the same service instance to serve the communication throughout the lifetime of this communication).

Specifically, although in the case of the QUIC protocol, the communication identifiers used by the communication devices during a communication are conveyed in unencrypted form and can be used by the aforementioned entities, they do not possess the means to correlate these identifiers and therefore to associate them with one and the same communication, when these communication identifiers are modified during the communication. Specifically, and as previously stated, the list of the communication identifiers authorized for the QUIC communication has been exchanged in an encrypted manner by the two communication devices, which makes it difficult or even impossible for an intermediate entity to associate the different communication identifiers with one and the same QUIC communication.

To remedy this problem, it can be envisioned to involve the intermediate entity in the aforementioned encryption mechanism (the intermediate entity then behaving as a proxy having access to the data encrypted by the communication devices). However, this solution is not satisfactory since it greatly affects the performance of this entity (and therefore the experience perceived by the users) due to the decryption (and, where applicable, encryption) operations that it must implement. It also weakens the robustness of the communications in the event of unavailability of this intermediate entity.

It can also be envisioned to introduce a checking entity in the network (typically an SDN (Software-Defined Networking controller)), in charge of informing the intermediate entities of an upcoming modification of a communication identifier. But such a solution makes it necessary to warn this control entity before any connection migration (i.e. modification and actual use of the communication identifier), which considerably increases the signaling traffic and hence penalizes the time needed to carry out the migration of connection. Furthermore, the control entity can fail to communicate the new communication identifiers to the intermediate entity.

The invention concerns a solution which does not have the aforementioned drawbacks.

### SUMMARY OF THE INVENTION

According to a first aspect, the invention thus relates to a method for managing a communication between at least a first communication device and at least a second communication device in a communication network, the method being implemented by a so-called intermediate entity placed on at least one path taken by data packets of this communication. This method includes:
a step of obtaining a communication identifier conveyed in a data packet exchanged during this communication, and
a step of handling the data packet as a function of a result of a check of the conformity of the communication identifier to at least one communication identifier mask accessible by the intermediate entity.

Correspondingly, the invention relates to a so-called intermediate entity configured to be placed on at least one path taken by data packets of a communication between at least a first communication device and at least a second communication device in a communication network, this entity including:
an obtaining module configured to obtain a communication identifier conveyed in a data packet exchanged during this communication; and
a handling module configured to handle this data packet as a function of a result of a check of the conformity of the communication identifier to at least one communication identifier mask accessible by this intermediate entity.

Within the meaning of the invention, it is considered that a communication identifier mask is accessible by an intermediate entity as soon as the intermediate entity can have knowledge of this identifier mask. The communication identifier mask can for example be stored by the intermediate entity, or be obtained by the intermediate entity from another item of equipment via the communication network.

According to a second aspect, the invention relates to a communication method implemented by a first communication device in a communication network, this method including:
a step of generating at least one identifier intended to be used as a communication identifier in a communication between this first communication device and at least a second communication device, this identifier conforming to at least one communication identifier mask accessible by at least one intermediate entity placed on at least one path taken by data packets of this communication; and
a step of sending at least one data packet including this identifier in the context of this communication.

Correspondingly, the invention relates to a communication device including:
a module for generating communication identifiers configured to generate at least one identifier intended to be used as a communication identifier in a communication between this communication device and at least a second communication device in a communication network, this identifier conforming to at least one communication identifier mask accessible by at least one intermediate entity placed on at least one path taken by data packets of this communication; and
a module for sending data packets configured to send at least one data packet including this identifier in the context of this communication.

According to a third aspect, the invention concerns a communication system including at least:
a communication device as mentioned above, this communication device being configured to communicate with at least a second communication device; and
an intermediate entity as mentioned above configured to be placed on at least one path taken by the data packets of a communication set up between these communication devices.

Thus, and in general, the intermediate entity in accordance with the invention, checks, to manage a communication set up between two communication devices, whether or not a communication identifier conveyed in a packet of this communication is in accordance with an identifier mask. For example, in a particular embodiment, the intermediate entity checks whether or not the communication identifier is formed on the basis of at least one communication identifier mask to which it has access. Such an intermediate entity is for example an entity located on a path of the communication envisioned and able to handle data packets exchanged during this communication.

The use of such a mask allows the intermediate entity to manage a communication between the communication devices by applying particular handling to at least some of these packets even if the communication identifiers vary during the communication. Specifically, the intermediate entity does not need to implement a logic or a structure that would set up a history or any link of any kind between the communication identifiers used by the different devices during one and the same communication. This logic is replaced by the simple checking of the conformity of the identifier to the mask.

This solution therefore in particular makes it possible to comply with the confidentiality restrictions of the QUIC protocol as previously described, and at lower cost.

The invention does not in any way require the intermediate entity to perform any encryption/decryption operation, the role of this entity being essentially to check the conformity of a communication identifier to one or more identifier masks. In a particular embodiment, this operation of checking said conformity may essentially consist in a comparison and can be carried out by embodying a simple logic “AND” between the identifier and the mask.

Note moreover that, advantageously, the intermediate entities do not play a role of proxy for the implementation of the invention.

Nor does the invention require the introduction of a control entity (whether centralized or distributed), the role of which would be to inform the intermediate entities of upcoming modifications of the communication identifiers (migration of connections described previously). The communication devices may consequently modify the communication identifiers at any time, without prior notification of an external entity. Thus, and very advantageously, the invention does not complicate the engineering of the network.

In particular, the cryptographic keys used by the communications to encrypt their communications are not communicated to the intermediate entities: the invention thus advantageously avoids introducing a security breach related to the use of these intermediate entities.

For all these advantages in particular, the invention makes it possible to improve the management of the network resources and to improve the quality of the service delivered and perceived by the users.

In a particular mode of implementation of the communication method according to the invention, a communication identifier generated by a communication device can be used as a source communication identifier in a packet sent by this communication device.

In another embodiment of the communication method according to the invention, the first communication device sends, to the second communication device with which the communication has been set up, the encrypted communication identifier in a data packet. On receiving the packet, the remote communication device uses the received identifier as the destination communication identifier for a subsequent packet of the communication.

In accordance with the invention, the handling of a data packet takes into account the conformity of the communication identifier to the communication identifier mask. For example, all the packets received by the intermediate entity, and the communication identifier of which does not conform to the mask (for example because the identifier was not formed on the basis of the ad hoc communication identifier mask) can be blocked.

For example, in a particular embodiment of the managing method according to the invention, the intermediate entity implements a firewall function, and receives a mask of a communication device, the communication of which it manages. The step of handling a data packet includes the filtering of this packet as a function of the conformity or otherwise of the communication identifier, for example according to whether or not it was formed on the basis of the mask received from this communication device.

In this embodiment, the firewall may, for example, communicate one or more instructions for generating masks to the communication devices it protects and receive, from at least one of these devices, a communication identifier mask generated from these instructions, the firewall being able to be configured to block the incoming and/or outgoing packets conveying a communication identifier that does not comply with such a mask. This embodiment of the invention can in particular be implemented to:
filter the packets received by a communication device, by checking the conformity of the destination communication identifier to the mask; and/or to
filter the packets transmitted by a communication device by checking the conformity of the source communication identifier to the mask.

In an embodiment of the managing method according to the invention, the intermediate entity receives the communication identifier mask from a communication device and associates this mask with this communication device, and the handling step is furthermore determined as a function of the communication device associated with said mask.

In a particular embodiment, the communication method according to the invention includes:
a step of generating, by the first communication device, at least one communication identifier mask by applying at least one communication identifier mask generation instruction; and
a step of registering this mask with the intermediate entity.

For example, in an implementation of this particular embodiment, the managing method according to the invention includes:
a step of sending an announcement message including at least one communication identifier mask generation instruction;
the communication identifier mask being received from the communication device in response to the announcement message.

Correspondingly, in a particular implementation, the communication method according to the invention includes a step of receiving, by the first communication device, an announcement message including at least mask generation instruction from an intermediate entity.

This particular embodiment of the invention is particularly advantageous when the intermediate entity implements a traffic routing (forwarding) function, or a traffic load balancing function intended for several communication devices, each of these communication devices generating its own communication identifier mask by applying the received instruction or instructions. In this embodiment, the handling of a packet by the intermediate entity can include checking that a communication identifier of a packet corresponds to a mask of a given communication device then routing this packet to this given communication device.

The announcement message can for example be received in response to a discovery message sent by the first communication device.

This particular embodiment allows an intermediate entity to announce itself in the network and communicate its instruction or instructions to the communication devices.

In a particular embodiment of the managing method according to the invention, this announcement message includes a service identifier which identifies a service, the packets of which can be handled by the intermediate entity.

An intermediate entity in accordance with the invention does not necessarily define itself the instruction or instructions it uses to check the conformity of a communication identifier conveyed by a packet it is handling.

In a particular embodiment wherein the intermediate entity offers a given function, the managing method according to the invention can include a step of receiving, from at least one communication device, at least one communication identifier mask generated by this communication device on the basis of at least one communication identifier mask generation instruction supplied by another intermediate entity offering this given function.

For example in a particular mode of implementation of the communication method according to the invention, the first communication device:
determines that a first intermediate entity offers the same function as another intermediate entity; and
registers with this first intermediate entity a communication identifier mask in application of said at least one mask generation instruction used by this other intermediate entity.

Thus, and very advantageously:
both intermediate entities use the same communication identifier masks;
the packets of one and the same communication may be routed to one and the same communication device whatever the intermediate entity involved in the routing of the packets; and
the first communication device uses the same communication identifier mask to communicate with the intermediate entities offering the same function.

This embodiment of the invention is particularly advantageous since it allows the first intermediate entity to obtain masks generated in application of generation instruction(s) supplied by another intermediate entity without there being any communication previously set up between these intermediate entities.

If the first intermediate entity receives, from several communication devices, a plurality of communication identifier masks generated by these communication devices according to the instructions for generation of communication identifier masks supplied by another intermediate entity, this first intermediate entity can deduce the instructions for generation of communication identifier masks of this other intermediate entity.

This embodiment can for example be implemented when a second intermediate entity is introduced to replace a first intermediate entity. In this case, the second intermediate entity can simply announce itself to the communication devices, which register with it a number of communication identifier masks in application of the instruction or instructions they had received from the first intermediate entity.

In a particular embodiment of the invention, the first communication device can generate a communication identifier mask and register it with an intermediate entity without receiving the instruction or instructions from this intermediate entity.

In a particular embodiment, the managing method according to the invention includes:
a step of detecting conflicts, a conflict being detected if a communication identifier mask received from a communication device constituting an instance of a service has already been associated by the intermediate entity with at least one other communication device constituting a different instance of the same service; and
a step of triggering a modification of said communication identifier mask by at least one of these communication devices.

In a particular embodiment, if the intermediate entity receives from a communication device a request to register a communication identifier mask that has already been used, it can reject this registration request or ask the communication device to propose a new mask to it.

In a particular embodiment, before registering, with a first intermediate entity, for a given service, a mask generated in application of one or first instructions, the first communication device checks that it has not already registered, with another intermediary, a mask for the same service and generated by applying different instructions. This embodiment makes it possible to avoid mask generation conflicts and consequently communication identifiers for one and the same service.

In a particular embodiment, if the first communication device determines that it has already registered a mask for the same service with another intermediate entity, it registers with the first intermediate entity a mask generated according to these other instructions, such as to guarantee the consistency of the masks.

In a particular embodiment, the method for managing a communication according to the invention includes:
a checking step to check whether or not said intermediate entity can handle the data packets of a communication involving the communication device as a function of:
(i) a number of communication devices already registered by the intermediate entity in association with a communication identifier mask generated in application of said at least one mask generation instruction; and
(ii) a number of bits defined by said at least one instruction; and
if this is not the case, a step of sending a reset message with at least one new mask generation instruction defining a greater number of bits, said reset message asking the communication device and the communication devices already registered to generate a new communication identifier mask by applying said at least one new instruction.

This embodiment advantageously allows the intermediate entity to proceed to the migration of communication identifiers to be able to handle more communication devices and thus avoid rejecting the registration requests received from the new communication devices.

It is important to note that the intermediate entity according to the invention does not itself generate the communication identifiers. At the most, it defines instructions, typically the bits it will use to execute its service (e.g. checking the conformity of communication identifiers formed on the basis of a mask, handling the packets it routes as a function of the mask). These bits are the bits of the communication identifiers that the intermediate entity considers as “significant” since they are the ones that it analyzes to determine whether or not they conform to the identifier mask(s) it is considering. In the remainder of the description, these bits will be referred to as “significant bits” of the communication identifier.

The communication identifier mask generation instructions defined in the invention thus make it possible for example to determine the position and value of the significant bits of the communication identifier.

For example these instructions may include:
integers used to obtain the position of the first and last significant bits of a sequence of bits including the significant bits of said communication identifier; and
an optional integer indicating the positions of the significant bits of said communication identifier within said sequence.

In an embodiment of the invention, said at least one mask generating instruction includes at least one item of information from among:
an item of information representative of a position of a first bit of a communication identifier corresponding to a mask of this identifier;
an item of information representative of a position of a last bit of this communication identifier corresponding to this mask; and
an item of information representative of the positions or of a number of bits of this communication identifier corresponding to this mask.

In a particular embodiment, the communication between the first communication device and the second communication device is compliant with a communication protocol based on the UDP transport protocol, for example the QUIC protocol.

It is recalled that the QUIC protocol is a transport protocol based on the UDP (User Datagram Protocol) and the design and use of which have in particular the aim of reducing the latency times generally observed when setting up TCP (Transmission Control Protocol) connections. For more information on the QUIC protocol, those skilled in the art can refer to the document “Iyengar, J. and M. Thomson, “QUIC: A UDP-Based Multiplexed and Secure Transport”, draft-ietf-quic-transport (work in progress), 2019″.

However, the QUIC protocol is cited by way of example, and the invention is applicable to any other protocol, particularly other protocols based on the UDP protocol, with a preferred application in the context of protocols implementing, like QUIC, an encryption of useful data and of certain items of control information of the communication.

The invention also concerns a computer program on a recording medium, this program being able to be implemented in a computer. This first program includes instructions suitable for implementing a communication managing method as described above.

The invention also concerns a computer program on a recording medium, this program being able to be implemented in a computer. This second program includes instructions suitable for implementing a communication method as described above.

Each of these programs can use any programming language, and be in the form of source code, object code, or intermediate code between source code and object code, such as in a partially compiled form, or in any other desirable form.

The invention also concerns an information medium or a recording medium readable by a computer, and including instructions of the first or of the second computer program as mentioned above.

The information or recording media can be any entity or device capable of storing the programs. For example, the media may include a storage means, such as a ROM, for example a CD-ROM or a microelectronic circuit ROM, or else a magnetic recording medium, for example a diskette (floppy disk) or a hard disk, or a flash memory.

Additionally, the information or recording media can be transmissible media such as an electrical or optical signal, which can be conveyed via an electrical or optical cable, by radio link, by wireless optical link or by other means.

The programs according to the invention can in particular be downloaded over a network of Internet type.

Alternatively, each information or recording medium can be an integrated circuit into which a program is incorporated, the circuit being suitable for executing or for being used in the execution of one of the methods in accordance with the invention.

### BRIEF DESCRIPTION OF THE DRAWINGS

Other features and advantages of this invention will become apparent from the description given below, with reference to the appended drawings which illustrate an exemplary embodiment thereof without any limitation. In the figures:

FIG. 1 shows a QUIC communication of the prior art;

FIG. 2 shows a QUIC packet of the prior art;

FIG. 3 shows a QUIC communication between two communication devices of the prior art;

FIG. 4 illustrates a discovery mechanism which can be implemented in a particular embodiment of the invention;

FIG. 5 shows an announcement message which can be used in a particular embodiment of the invention;

FIG. 6 shows an intermediate entity instance table which can be used in a particular embodiment of the invention;

FIG. 7 shows a registration message which can be used in a particular embodiment of the invention;

FIG. 8 shows a communication device instance table which can be used in a particular embodiment of the invention;

FIG. 9 shows a format of a mask generation instruction which can be used in a particular embodiment of the invention;

FIGS. 10A to 10E show examples of instructions in accordance with the format of FIG. 9;

FIG. 11 illustrates steps of a method for managing a communication in accordance with a particular embodiment of the invention;

FIG. 12 shows a communication device table used in an exemplary implementation of the invention;

FIG. 13 shows a process which can be implemented for the activation of an intermediate entity in a particular embodiment of the invention;

FIG. 14 illustrates a mechanism which can be implemented by a communication device in accordance with a particular embodiment of the invention to optimize the handling of the traffic when it receives packets from several intermediate entities in accordance with the invention;

FIG. 15 illustrates a process which can be implemented in the invention to withdraw an intermediate entity;

FIG. 16 illustrates an example of an update of a service instance table in a particular mode of implementation of the invention;

FIG. 17 illustrates a first example for replacing one intermediate entity with another in a particular embodiment of the invention;

FIG. 18 illustrates a second example for replacing one intermediate entity with another in a particular embodiment of the invention;

FIG. 19 illustrates a first example for replacing one communication device with another in a particular embodiment of the invention;

FIG. 20 shows a process for resetting a communication identifier mask on the initiative of a communication device in accordance with a particular embodiment of the invention;

FIG. 21 illustrates the updating of a communication device table in a particular embodiment of the invention following a modification of a communication identifier mask;

FIG. 22 shows a process for resetting a communication identifier mask on the initiative of an intermediate entity in a particular embodiment of the invention;

FIG. 23 shows a process of introducing a new communication device in accordance with a particular embodiment of the invention;

FIG. 24 illustrates a particular mode of implementation of the invention wherein the intermediate entity is a firewall;

FIG. 25 illustrates a communication device table which can be used in the context of the embodiment of FIG. 24;

FIG. 26 shows the hardware architecture of an intermediate entity in accordance with a particular embodiment of the invention;

FIG. 27 shows the hardware architecture of a communication device in accordance with a particular embodiment of the invention; and

FIG. 28 shows a system in accordance with a particular embodiment of the invention.

### DETAILED DESCRIPTION OF SEVERAL EMBODIMENTS OF THE INVENTION

The invention will now be described in the particular situation in which the communication devices are setting up a communication according to the QUIC protocol.

This invention in particular concerns a method for managing a communication and a communication method. In this application, a “communication” between two items of equipment refers to all the exchanges between the set-up, maintaining and termination of this communication.

In the particular context of the QUIC protocol, a communication within the meaning of the invention is also referred to as a “connection”. Consequently, if the word connection is used in the remainder of the description, it refers to a communication within the meaning of the invention. Thus, a “connection identifier” in the particular context of the QUIC protocol is a communication identifier within the meaning of the invention. Correspondingly, when in the remainder of the description reference is made to a communication identifier in the context of the QUIC protocol, it is a connection identifier (or CID for Connection IDentifier) within the meaning of the QUIC protocol.

FIG. 1 shows a QUIC connection (or communication) CQ between two communication devices PT₁ and PT₂. A QUIC communication makes it possible to multiplex different channels of communication Cᵢ (streams) through which data packets P are routed. The communication devices PT₁ and PT₂ may for example be a terminal (hereinafter bearing the reference PT_{UT}), a client (bearing the reference PT_{CT}) or a service instance (bearing the reference PT_{IS}). One or the other of the communication devices can set up a communication channel Cᵢ. The communication device which originates the set-up of a channel is known as the “source” and bear the reference PT_{SO}; the other communication device with which this channel is set up is known as the “destination” and will be bear the reference PT_{DE}. In one figure, one and the same communication device may have several reference numbers, for example PT_{IS} and PT_{SO} for a source communication device of service instance type.

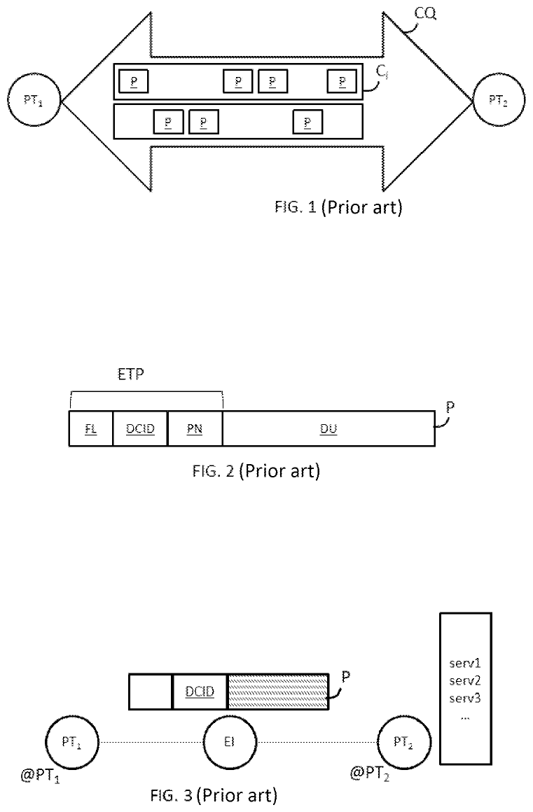

A QUIC packet P, shown in FIG. 2 includes a public header ETP and useful data DU. In such a packet, the useful data DU are encrypted, and include the items of communication control information. A QUIC packet includes a public header ETP itself including flags (flags FL), a communication identifier (or “connection identifier” as indicated above) and a packet number PN. The communication identifier is sent in unencrypted form. The identifier of a communication channel Cᵢ, not shown in FIG. 2, is encrypted. The QUIC connection identifier is an example of a communication identifier described previously.

The QUIC specification distinguishes the communication identifier associated with the source (and denoted SCID for Source Connection Identifier) of the communication identifier associated with the destination (and denoted DCID for Destination Connection Identifier).

The packet of FIG. 2 is a QUIC packet with a short header ETP. In such packets, the public header ETP includes only the communication identifier of the destination, i.e. the DCID. The QUIC specification also defines a long header including the communication of the destination DCID and the communication identifier of the source SCID.

Note that it is usual for those skilled in the art to refer to the pair {DCID, SCID} as “communication identifier CID (Connection IDentifier)”. It is also commonly, if inaccurately, said that the communication identifier CID includes two parts, a source part SCID and a destination part DCID. In the description of the invention, the concept of communication identifier (or connection identifier) therefore includes both the pair {DCID, SCID} and the identifiers DCID and SCID independently.

FIG. 3 shows a QUIC communication set up between two connection devices PT₁ and PT₂, an intermediate entity EI placed on the path taken by the characteristic packets of this communication as seen by the intermediate entity EI For this intermediate entity EI all the data of the QUIC packet (shown by the shaded area) are encrypted, with the exception of the communication identifier SCID or DCID (in the example of a short ETP header). Within the meaning of the QUIC protocol, a communication is identified by:
the quadruplet formed by the source IP address and the source port number of the source communication device and the destination IP address and the destination port number of the communication device receiving the packet; and by
the communication identifier SCID or DCID.

In the description of this application the pair {IP address, port number} of an item of equipment or of a function E is denoted @E.

Certain figures will be described in particular embodiments wherein the intermediate entities implement a traffic load balancing function or a firewall function. These intermediate entities may then simply be referred to as “load balancers” or “firewalls” and respectively bear the reference EI_{LB} or EI_{FW}.

In the description hereinafter, the steps bearing the reference EXX are implemented by a communication device and the steps bearing the reference FXX are implemented by an intermediate entity.

FIG. 3 also illustrates that a communication device can supply several services, for example serv1, serv2, serv3, . . . . In the remainder of the description the identifier referring to such a service is denoted sere id.

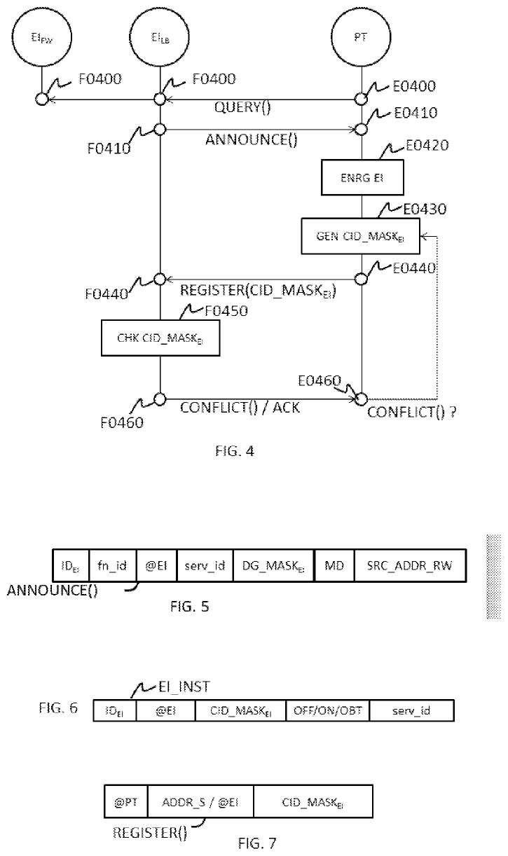

FIG. 4 illustrates how, in a particular mode of implementation of the invention, a communication device PT in accordance with the invention can:
discover intermediate entities EI in accordance with the invention;
generate one or more communication identifier masks in application of one or more mask generation instructions received from an intermediate entity. In the example envisioned here, a plurality of mask generation instructions are considered, but the invention is also applicable in a context where a single mask generation instruction is received from the intermediate entity; and
ask this intermediate entity EI to register one or more of these masks if no conflict is detected.

The context of FIG. 4 is that of a network including a communication device PT and two intermediate entities, namely a firewall EI_{FW} and a load balancer EI_{LB}.

In the embodiment described here, in a step E0400, the communication device PT in accordance with the invention sends a discovery message QUERY to detect any intermediate entities EI in accordance with the invention.

In the embodiment described here, the discovery message QUERY is sent to a broadcasting address ADDR_S listened to by all the intermediate entities EI.

If the communication device seeks to discover only intermediate entities implementing a given function (for example a load balancing function), the discovery message QUERY includes a service clause fn_id identifying this traffic load balancing function. This clause is optional.

It is assumed that the intermediate entities EI are listening over the broadcasting address ADDR_S to which the communication devices PT are sending the discovery messages QUERY.

In a step F0400, the intermediate entities EI receive the discovery message QUERY.

In the embodiment described here:
all the intermediate entities EI that receive the discovery message QUERY answer it if this message does not include any service clause; and
when the discovery message QUERY includes such a clause, only the intermediate entities EI implementing the function identified by this clause answer it.

In the embodiment described here, to answer the discovery message QUERY and announce its presence to the communication devices PT, an intermediate entity EI sends, in a step F0410, an announcement message ANNOUNCE to a broadcast address or to a multicast address reserved for this use ADDR_L, the source address of this message being a unicast IP address @EI of the intermediate entity EI.

To simplify FIG. 4, a case is shown where only the load balancer EI_{LB} answers, by the sending of an announcement message ANNOUNCE, the discovery message QUERY.

FIG. 5 shows an announcement message ANNOUNCE which can be used in the invention.

In the embodiment described here, the announcement message ANNOUNCE can include an identifier IDE′ of the intermediate entity EI (for example its IP address @EI), an identifier fn_id of the function implemented by this intermediate entity (for example a load balancing function, firewall function etc.) and one or more service identifiers sere id of the services of the communication device PT to which the intermediate entity EI is authorized to offer its function (for example its load balancing function or its firewall function).

These service identifiers can be defined by an administrator of a network which hosts communication devices in accordance with the invention and supplying these services. For example, if the intermediate entity EI offers a traffic load balancing function, the announcement messages ANNOUNCE sent by this intermediate entity may include service identifiers, the load of which can be balanced by this entity. These service identifiers can be structured in the form of an alias, a FQDN (Fully Qualified Domain Name), etc.

The announcement message ANNOUNCE can also include one or more mask generation instructions DG_MASK allowing a communication device to create one or more of these communication identifier masks in application of these instructions. According to the scenarios of implementation of the invention, the communication identifiers created on the basis of this mask can be source communication identifiers SCID and/or destination communication identifiers DCID.

By sending its instructions for the generation of masks to the communication devices, the intermediate entity expects that these communication devices will generate communication identifier masks in application of these instructions since they are registering them with it.

These instructions are intended to be used by the intermediate entity to determine, when it intercepts a packet, the mask of the communication identifier SCID or DCID conveyed in this packet on the basis of this communication identifier and to check whether or not this identifier conforms with the identifier mask thus determined.

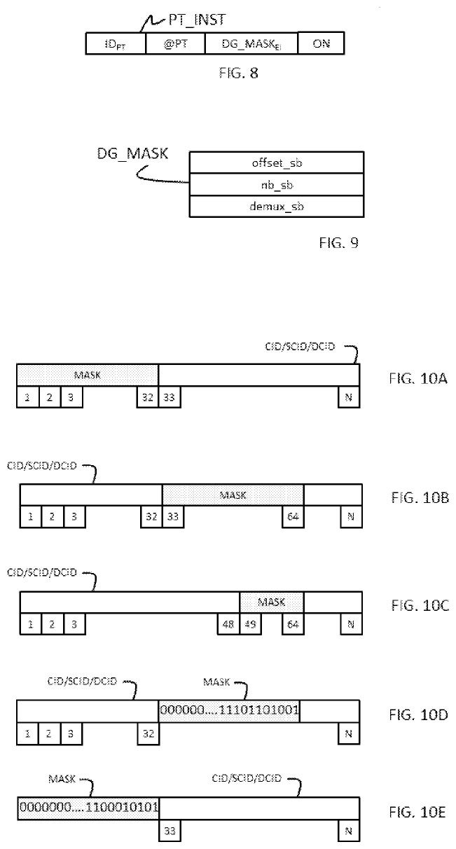

An example of a DG_MASK instruction format will be described with reference to FIG. 9 and examples of instructions using this format will be described with reference to FIGS. 10A to 10E.

In the embodiment described here, the announcement message ANNOUNCE can include a “broadcast mode” field MD which defines a communication device PT must answer this announcement message. In the embodiment described here, the broadcast mode MD can take two values that define whether or not the communication device PT must answer this message using the broadcast address ADDR_S used in step E0400 or using a unicast address @EI of the intermediate entity.

In the embodiment described here, the announcement message ANNOUNCE includes a parameter defining whether or not the intermediate entity EI rewrites the address of the packets it relays to a communication device PT.

With reference to FIG. 4, the communication device PT receives the announcement message ANNOUNCE announcing the presence of the intermediate entity EI_{LB} in a step E0410.

If the announcement message ANNOUNCE includes an identifier fn_id of a function which does not correspond to the one sought by the communication device PT, the communication device PT ignores the announcement message ANNOUNCE. It is assumed in the example of FIG. 4 that this is not the case.

In the embodiment described here, in a step E0420, the communication device PT registers an identifier IDE of the intermediate entity EI_{LB} in an intermediate entity table denoted EI_INST and shown by FIG. 6. In the embodiment described here, the communication device PT moreover registers in it an address @EI of the intermediate entity and other items of information (not shown), for example a security context and a timestamp of the last message received by this intermediate entity. The identifier ID_{EI} of the intermediate entity can be generated locally by the communication device PT on the basis of the information conveyed in the announcement message ANNOUNCE. The communication devices PT can locally use different identifiers IDE to identify one and the same intermediate entity EI.

In a step E0430, the communication device PT generates at least one communication identifier mask CID_MASK_{EI} in application of one or more mask generation instructions DG_MASK_{EI}.

This communication identifier mask is intended to be used by the communication device PT for its communications involving the intermediate entity EI_{LB}. In the embodiment described here, this mask is also intended to be used by the communication device PT for its communications involving one or more other intermediate entities offering the same function (traffic load balancing) as the intermediate entity EI_{LB}.

Consequently, the communication device PT registers the communication identifier mask CID_MASK_{EI} in the intermediate entity instance table EI_INST in association with the intermediate entity EI_{LB} and in association with the other intermediate entities offering the traffic load balancing function.

In the embodiment described here, this mask is initially associated in the table EI_INST with a state OFF representing the fact that it has not yet been accepted by the intermediate entity EI.

In the embodiment described here, the state associated with a communication identifier mask in an intermediate entity instance table EI_INST managed by a communication device can take three values, namely:

the state “OFF” representing the fact that the mask is not yet used or is no longer used by the communication device, for example because it has not been accepted by the intermediate entity EI. When the mask is associated with the state OFF, it is also said that this mask is “inactive”;
the state “ON” if the mask is actually used by the communication device; and
the state “OBT” (On But Terminating) indicating that the mask is active but intended to become inactive, for example after a given expiry period or after the termination of the last active communication between the communication device and the intermediate entity in question.

In the embodiment described here, the intermediate entity instance table EI_INST also stores the identifiers serv_id of the services supplied by communication devices which can be accessed according to the execution of the function offered by the intermediate entity (traffic load balancing, firewall etc.)

In a step E0440, the communication device PT sends in a unicast mode (or broadcasts) a registration message REGISTER including the communication identifier mask CID_MASK_{EI} to register this mask with the intermediate entity EI, namely here with the load balancer EI_{LB}. This message can include a service identifier serv_id corresponding to the service supplied where applicable by the communication device PT.

In the embodiment described here, the communication device sends in a unicast mode (or broadcasts) a registration message REGISTER in accordance with the broadcast mode MD contained in the announcement message ANNOUNCE received in step E0410: the destination address is either the unicast IP address @EI of the intermediate entity EI_{LB} or the broadcast address ADDR_S. The source address of the REGISTER message is a unicast IP address @PT assigned to the communication device. This register message REGISTER can be sent several times to refresh the registration of the cx CID_MASK_{EI} with the intermediate entities EI in question, with the load balancer EI_{LB}.

In the embodiment described here, the registration message REGISTER further includes an identifier ID_{PT} of the communication device PT.

In an embodiment of the invention and as shown in FIG. 7, the identifier of the communication device used in the registration message REGISTER is the IP address (and port) @PT used by said communication device.

This identifier can also be an alias, a domain name etc. The identifier used by an intermediate entity to identify a communication device is a decision local to the entity.

In another particular embodiment of the invention, if a secure tunnel, for example of TLS (Transport Layer Security) type is used for sending the registration message REGISTER, this identifier can be the DNS-ID field of the ClientHello Message.

The registration message REGISTER is received by one or more intermediate entities EI in a step F0440; this intermediate entity EI registers the identifier of the communication device PT in a communication device instance table PT_INST, an example of which is illustrated by FIG. 8.

In the embodiment described here, the intermediate entity EI also registers in the communication device instance table PT_INST an IP address @PT of the communication device PT. It can also register in it a MAC address of the communication device as well as a security context; these latter items of information are not shown in the table PT_INST of FIG. 8.

In the embodiment described here, if the communication device PT is an instance PT_{IS} of a given service, the intermediate entity EI checks in a step F0450 whether or not the communication identifier mask CID_MASK_{EI} received in step F0440 is identical to a communication identifier mask already received for another instance of the same service. This situation constitutes a conflict within the meaning of the invention.

In the embodiment described here, if the intermediate entity detects such a conflict, it sends in a step F0460 a conflict-reporting message CONFLICT to the communication device PT_{IS}. Otherwise it registers the communication identifier mask CID_MASK_{EI} in the communication device instance table PT_INST in association with a state ON representative of the use of this mask by the communication device PT_{IS} and sends an acknowledgement (ACK) of receipt, to this communication device PT_{IS}.

In the embodiment described here, the state associated with a communication identifier mask in a communication device instance table PT_INST managed by an intermediate entity EI can take three values, namely:
the state “ON” if the mask is active, i.e. in use by the communication device;
the state “OFF” if the mask is inactive, for example because it has not been accepted by the intermediate entity EI;
the on-but-terminating state “OBT” indicating that the mask is active but will become inactive, for example after a given expiry period or after the termination of the last active communication between this intermediate entity and the communication device.

In practice, in the embodiment described here, an intermediate entity EI detects a conflict if it identifies in its communication device instance table PT_INST two registrations including one and the same communication identifier mask in the ON state associated with these two different instances of one and the same service.

The conflict-reporting message CONFLICT or the positive acknowledgment ACK is received by the communication device in a step E0460.

If the communication device receives a conflict-reporting message CONFLICT, the communication device PT again executes:
step E0430 to generate at least one other communication identifier mask CID_MASK_{EI2} using the mask generation instructions DG_MASK_{EI}, then to register this new communication identifier mask CID_MASK_{EI2} in the intermediate entity instance table EI_INST; and
step E0440 to send a registration message REGISTER including the new communication identifier mask CID_MASK_{EI2} to register it with the intermediate entity EI.

This procedure can be repeated several times, until the intermediate entity EI considers that the communication identifier mask CID_MASK_{EI2} received from the communication device PT in step F0440 is not in conflict with a communication identifier mask used by another termination point.

In the embodiment described here, if the communication device PT receives in step E0460 an acknowledgment message ACK, it considers that the communication identifier mask CID_MASK_{EI} is confirmed and it changes its state to ON in its intermediate entity instance table EI_INST.

FIG. 9 shows a format of mask generation instructions DG_MASK which can be supplied by an intermediate entity EI to a communication device PT to allow it to generate a communication identifier mask on the basis of which it will be able to generate communication identifiers.

In the embodiment described here, these instructions DG_MASK_{EI} may include:
an item of information representative of a position of a first bit of a communication identifier formed on the basis of a mask of this identifier;
an item of information representative of a position of a last bit of this communication identifier corresponding to this mask; and
an item of information representative of the positions or of a number of bits of this communication identifier corresponding to this mask.

In the examples hereinafter, the following optional integers may be used:
(i) nb_sb: integer indicating the number of “significant” bits of the communication identifier, i.e., as mentioned previously, the ones that should be considered when checking the conformity of the identifier to the mask;
(ii) offset_sb: integer indicating the offset of the first significant bit of the communication identifier;
(iii) demux_sb: integer indicating the position of the significant bits of the communication identifier.

FIG. 10A supplies an example wherein the offset offset_sb is not supplied, the number nb_sb of significant bits is equal to 32 and the integer demux_sb is not supplied: the significant bits of the mask are the 32 first bits of a communication identifier. In this example, the communication device can thus choose a mask from among the values between “0” and “4294967295”, or 2³² values. The value chosen by a communication device will be positioned in the 32 first bits of all the communication identifiers chosen by this communication device.

FIG. 10B supplies an example wherein the offset offset_sb is equal to 32, the number nb_sb of significant bits is equal to 32 while the integer demux_sb is not supplied: the significant bits are the bits in positions 33 to 64 of a communication identifier. In this example, the communication device can thus choose a mask from among the values between “0” and “4294967295”, or 2³² values. The value chosen by a communication device will always be positioned in the bits 33 to 64 of all the communication identifiers chosen by this communication device.

FIG. 10C supplies an example wherein the offset offset_sb is equal to 48, the number nb_sb of significant bits is equal to 16 while the integer demux_sb is not supplied: the significant bits are the bits of positions 49 to 64 of a communication identifier. In this example, the communication device can thus choose a mask from among the values between “0” and “65535”, i.e. 2¹⁶ values. The value chosen by a communication device will always be positioned in the bits 49 to 64 of all the communication identifiers chosen by this communication device.

FIG. 10D supplies an example wherein the offset offset_sb is equal to 32, the number nb_sb of significant bits is equal to 32, and the integer demux_sb is equal to 1897 (namely the binary value 00000 . . . .11101101001): the significant bits are the bits 54, 55, 56, 58, 59, 61 and 64 of a communication identifier. In this example, the communication device can thus choose a mask from among the 128 possible values while respecting the position of the 7 significant bits, for example 1793, 1856, 1889, 18896, etc.

FIG. 10E supplies an example wherein the offset offset_sb is not supplied, the number nb_sb of significant bits is equal to 32, and the integer demux_sb is equal to 789 (namely the binary value 0000000 . . . .1100010101): the significant bits are the bits 23, 24, 28, 30 and 32 of a communication identifier. In this example, the communication device can thus choose a mask from among the 32 possible values, while respecting the position of the 5 significant bits, for example 21, 533, 722, 788, etc.

In the same way, a position last_sb of the last significant bit can be used instead of the integer demux_sb.

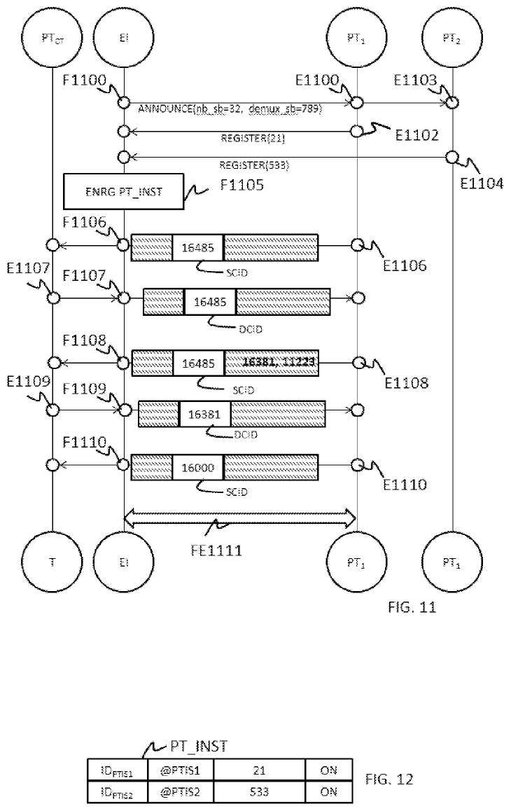

FIG. 11 illustrates steps of a method for managing a communication in accordance with an embodiment of the invention. To describe this figure the example of the FIG. 10E is repeated, and it is considered that an intermediate entity EI sends in a step F1100 an announcement message ANNOUNCE with mask generation instructions DG_MASK wherein the offset offset_sb is not provided, the number nb_sb of significant bits is equal to 32 and the integer demux_sb is equal to 789.

It is assumed that a first communication device PT₁ receives this announcement message (step E1100), generates a mask 21 in application of the instructions DG_MASK, and requests the registration of this mask 21 by the intermediate entity EI in step E1102.

It is also assumed that a second communication device PT₂ receives this announcement message (step E1103), generates the mask 533 in application of the instructions DG_MASK and requests the registration of this mask 533 by the intermediate entity EI_{LB} in step E1104.

In a step F1105 the intermediate entity EI registers these masks in its communication device instance table PT_INST, the latter being shown in FIG. 12.

It is assumed that this communication device PT₁ generates, in a step E1106, a communication identifier equal to 16415 and uses this identifier as a source communication identifier SCID to communicate with a communication device PT_{CT}, this communication identifier SCID effectively conforming since it is formed on the basis of the mask 21.

It is assumed that this communication device PT_{CT} sends, in step E1107, to the first communication device PT₁, a data packet including as destination communication identifier DCID the value 16415.

In this example, the intermediate entity EI intercepts this packet in step F1107 and checks whether or not the communication identifier DCID conveyed in unencrypted form in this packet is conforming, i.e. formed (or else produced or generated) on the basis of a mask registered in its communication device instance table PT_INST.

For this purpose, in this example, the intermediate entity EI applies the mask generation instructions DG_MASK_{EI} (parameters offset_sb not defined, nb_sb=32, demux_sb=789) to extract the mask of the identifier on the basis of the identifier 16415, as illustrated below:

16415(32bits)=00000000000000001000000000011111;

789=00000000000000000000001100010101

It deduces therefrom (AND operator), in this example, the value 21 (10101) of the mask and, by consulting its instance table PT_INST, that this packet is intended for the first communication device PT1. It therefore sends this packet to the first communication device PT1.

Consequently, once the intermediate entity EI has constructed its communication device instance table PT_INST, it can handle the communications received and forward them to the different communication devices PT₁, PT₂.

The invention is particularly advantageous when the intermediate entity EI is a load balancer EI_{LB} and the communication devices are instances PT_{IS1}, PT_{IS2} of one and the same service. Specifically, when a new communication is intercepted by this load balancing intermediary, typically with a destination communication identifier DCID equal to 0, the latter selects a service instance PT_{IS1} or PT_{IS2} as a function of a traffic load balancing algorithm with which it has been configured. The communication is then set up with the selected instance. This service instance selects a communication identifier that it transmits to the remote communication device PT_{CT} as source communication identifier SCID, this identifier conforming since it is formed on the basis of the mask generated in application of the mask generation instructions DG_MASK_{EI} received from the load balancer.

The load balancer EI_{LB} no longer needs to maintain a state to handle the traffic received from the remote communication device PT_{CT} for this communication. Specifically, when a packet of a communication that has already been set up is received by the load balancer EI_{LB}, in a new occurrence of step F1107, the latter extracts the destination communication identifier DCID, extracts the mask therefrom, and then consults its table PT_INST to identify the service instance corresponding to this mask.

It is now assumed that, during this same communication, the first service instance PT_{IS1} generates new communication identifiers (16381 and 11223) corresponding to the mask generated on the basis of the instructions DG_MASK_{EI} received from the load balancer EI_{LB}, and proposes to the remote communication device PT_{CT} these new communication identifiers (16381 and 11223) in an encrypted message (step E1108). It is advisable to note that since the message(s) transmitting the new communication identifiers are encrypted, its or their contents are not accessible by the load balancer EI_{LB}. The remote communication device PT_{CT} hence uses the communication identifier 16381 (or 11223 respectively) as DCID inserted into the packets of this communication set up with the first service instance PT_{IS1}.

On interception of the packets by the intermediate entity EI_{LB}, the latter extracts the communication identifier DCID 16381 (or 11223 respectively), extracts the mask 21 therefrom, and then consults its communication device instance table PT_INST to find the service instance which corresponding to this mask. In this way all the intercepted packets are sent to the same service instance PT_{IS1}.

In the embodiment described here, an intermediate entity EI can moreover check (as illustrated in steps F1106 and F1108) whether or not the source communication identifier SCID used by a communication device PT corresponds to the mask that has been communicated to it. If such is not the case, the intermediate entity can trigger a communication identifier mask negotiation procedure.

This variant makes it possible to detect an anomaly in its communication device instance table PT_INST. For example, still with reference to FIG. 11, it is assumed that the intermediate entity EI detects in step F1110 that a packet sent by the service instance PT_{IS1} includes a communication identifier (SCID=16000, in binary 11111010000000) which does not correspond to the mask (21, in binary 10101). Consequently, the intermediate entity EI_{LB} triggers a mask negotiation procedure FE1111. At the end of this procedure, the service instance PT_{IS1} registers a new mask (1664, in binary 11010000000) with the intermediate entity EI_{LB}. The intermediate entity EI_{LB} updates its communication device table PT_INST with the new mask 1664. The packets received by the intermediate entity with a destination communication identifier DCID equal to 16000 are sent to the service instance PT_{IS1}.

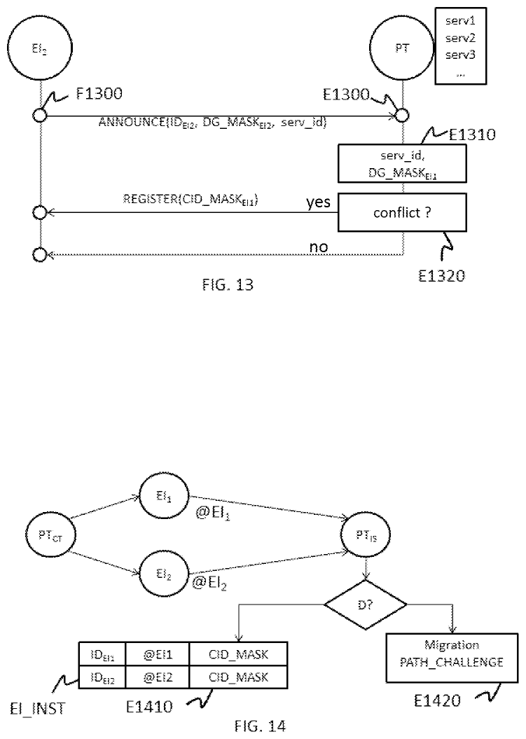

FIG. 13 shows in the form of a flow chart a process that can be implemented for the activation of an intermediate entity EI₂ in a particular embodiment of the invention.

It is assumed in this example that this new intermediate entity EI₂ sends, in a step F1300, an announcement message ANNOUNCE of the same type as that sent in the step F0410 already described. This announcement message ANNOUNCE can include mask generation instructions DG_MASK_{EI2} and one or more identifiers sere id of the services of the communication device which can be handled by the function supported by the intermediate entity (traffic load balancing, firewall).

It is assumed in this example that the announcement message ANNOUNCE is received in a step E1300 by a communication device PT which supplies several services, for example serv1, serv2, serv3, etc.

On receiving this announcement message, the communication device PT checks (step E1310) whether or not the ANNONCE message includes a service identifier serv_id and, where applicable, if the intermediate entity instance table EI_INST kept by this communication device, of the type of that described in FIG. 6, already includes an entry for the service identified by serv_id, associated with one or more mask generation instructions DG_MASK_{EI1} different from those DG_MASK_{EI2} received in this announcement message.

If such is the case, in the embodiment described here, and in order to avoid the conflict, the communication device PT does not create any new entry in the instance table EI_INST, to guarantee that this table does not include different mask generation instructions DG_MASK_{EI1}, DG_MASK_{EI2} for one and the same service serv_id.

Indeed, in the embodiment described here, several intermediate entities EI₁, EI₂ can offer one and the same function (traffic load balancing, firewall) to one and the same service serv_id, on condition that they supply consistent mask generation instructions DG_MASK_{EI}.

In the embodiment described here, when such a situation occurs, the communication device PT answers the announcement message by sending to the intermediate entity EI₂, in a step E1320, a registration message REGISTER including a communication identifier mask CID_MASK_{EI1} generated in application of the mask generation instructions received from the intermediate entity EI₁.

If the communication device PT determines in step E1310 that there is no conflict, it generates a communication identifier mask CID_MASK_{EI2} in application of the instructions conveyed in the announcement message received in step E1300 then registers it.

FIG. 14 is situated in the context of two intermediate entities EI₁, EI₂, placed on the path taken by the characteristic traffic of the communications set up between two same communication devices, here a client PT_{CT} and a service instance PT_{IS}, modify the source IP address of the packets sent to this service instance PT_{IS}.

In the example in FIG. 14, the packets received by the service instance PT_{IS} include a source IP address @EI₁ when they are received from the intermediate entity EL₁ and a source IP address @EI₂ when they are received from the intermediate entity EI₂, these packets including the same communication identifier SCID or DCID.

When the invention is implemented in the case of communications set up according to the QUIC protocol, in such a situation this protocol makes provision for the communication device PT_{IS} to transmit PATH_CHALLENGE messages on the occasion of each change of source IP address. The aim of these PATH_CHALLENGE messages is to check that the client PT_{CT} is legitimately authorized to use a path to send its packets.

In the embodiment of the invention described here, and in order to optimize the routing of the traffic through the network, the communication device PT_{IS} does not send, at least for a predetermined time D, for example 60 s, such a message PATH_CHALLENGE but keeps (step E1410) two entries in its intermediate entity instance table EI_INST.

In the embodiment, the service instance communication device PT_{IS} migrates the QUIC communication to the new IP address if it has not received any packet with another source address during the time period D. This migration consists in deleting, in step E1420, the entry corresponding to the old IP address from the table EI_INST.

Those skilled in the art will understand that it is not indispensable to delete the entry corresponding to the old IP address but that this is advantageous to avoid pointlessly encumbering the instance table EI_INST.

In the embodiment described here, at the expiry of the time period D, for example during the same step E1420, the service instance PT_{IS} can send the message PATH CHALLENGE to the client PT_{CT} in order to detect a possible attack. But this operation is not necessary to the implementation of this particular embodiment of the invention.

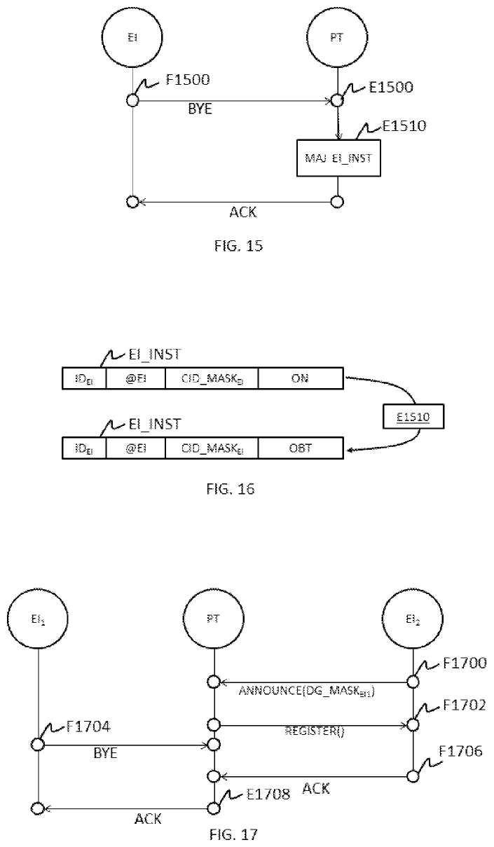

FIG. 15 shows in the form of a flow chart a process which can be implemented to withdraw an intermediate entity EI. To do this, the intermediate entity EI wishing to withdraw sends in unicast (or broadcasts), in a step F1500, a withdrawal message BYE to the communication devices PT associated with an active communication identifier mask in its communication device instance table PT_INST.

A communication device PT receives this withdrawal message BYE in a step E1500. In a step E1510, the communication device PT updates the intermediate entity instance table EI_INST, and more precisely the state associated with the communication identifier mask CID_MASK_{EI} used for this intermediate entity EI. In the embodiment described here, the state is modified to take the on-but-terminating value OBT to allow it to continue to temporarily handle the communications with this intermediate entity EI.

FIG. 16 illustrates the updating E1510 of the service instance table EI_INST.

In the embodiment described here, the communication device PT sends an acknowledgment of receipt ACK to the intermediate entity EI to inform it that the withdrawal message BYE has been taken into account.

In the embodiment described here, when a communication device PT receives a withdrawal message BYE from an intermediate entity, it continues to use the active mask CID_MASK_{EI} for this intermediate entity either during a given time period indicated in the withdrawal message BYE, or for as long as there is a communication set up with this intermediate entity EI.

FIG. 17 illustrates an example of replacement of an intermediate entity EI₁ by an intermediate entity EI₂ which can be implemented in a particular embodiment of the invention.

In this example, the intermediate entity EI₂ sends to a communication device PT, in a step F1700, an announcement message ANNOUNCE including one or more mask generation instructions DG_MASK_{EI1} identical to those announced previously by the intermediate entity EI₁.

It is assumed that the communication device PT is processing this announcement message as described with reference to FIG. 4 to generate an identifier mask in application of these instructions since it requests the registration of this mask with the intermediate entity EI₂ in a step E1702. The intermediate entity EI₂ acknowledges receipt of this registration in a step F1706.

In a step F7104 similar to step F1500, the intermediate entity EI₁ sends a withdrawal message BYE to the communication device PT to inform it that it is withdrawing. The communication device PT acknowledges this removal in a step E1708.

FIG. 18 illustrates an example of replacement of a first intermediate entity EI₁ by a second intermediate entity EI₂, this example being able to be implemented in another particular mode of the invention.

It is assumed in this example that a communication device PT has previously received an announcement message ANNOUNCE from the first intermediate entity EI₁ including first mask generation instructions DG_MASK₁ for a function fn_id and that this communication device has generated a communication identifier mask CID_MASK_{EI1} in application of these first instructions.

In accordance with step E0420 illustrated by FIG. 4, the intermediate entity instance table EI_INST of the communication device PT includes a registration of this mask CID_MASK_{EI1} in association with the intermediate entity EI₁.

It is now assumed that the communication device receives from the intermediate entity EI₂, in a step E1802, an announcement message ANNOUNCE including mask generation instructions DG_MASK₂ different from the instructions DG_MASK₁, for the same function fn_id.

It is assumed that the communication device PT determines in a step F1803 that the intermediate entities EI₁ and EI₂ offer the same function.

In the embodiment described here, the communication device answers the announcement message ANNOUNCE received from the second entity EI₂, in a step E1804, by a registration message REGISTER including the same items of information as those previously sent to the first entity EI₁ and in particular the communication identifier mask CD_MASK_{EI1} generated in application of the instructions DG_MASK₁ of the first intermediate entity EI₁ and not in application of the instructions DG_MASK₂ of the second intermediate entity EI₂.

The intermediate entity EI₂ acknowledges receipt of this registration in a step F1807.

In a step F1806 similar to step F1704, the intermediate entity EI₁ sends a withdrawal message BYE to the communication device PT to inform it that it is withdrawing. The communication device PT acknowledges receipt of this withdrawal in a step E1809.

The examples of FIGS. 17 and 18 illustrate situations wherein an intermediate entity EI₁ must be withdrawn whereas an intermediate entity EI₂ must be activated. The communication device receives a withdrawal message BYE from the intermediate entity EI₁ and an announcement message ANNOUNCE from the intermediate entity EI₂.

In these two embodiments, the communication device PT can update its intermediate entity instance table EI_INST to indicate that the intermediate entity EI₁ will soon be unavailable. The communication device can then proceed to the migration of communications to the intermediate entity EI₂ or the maintaining of the two contexts during a transition period. For example, a communication that has been set up with a communication identifier SCID or DCID can be routed via the intermediate entity EI₂ without modification of communication identifiers and without any interruption of communication.

The two announcement messages LB_ANNOUNCE and withdrawal messages BYE can be received in any chronological order.

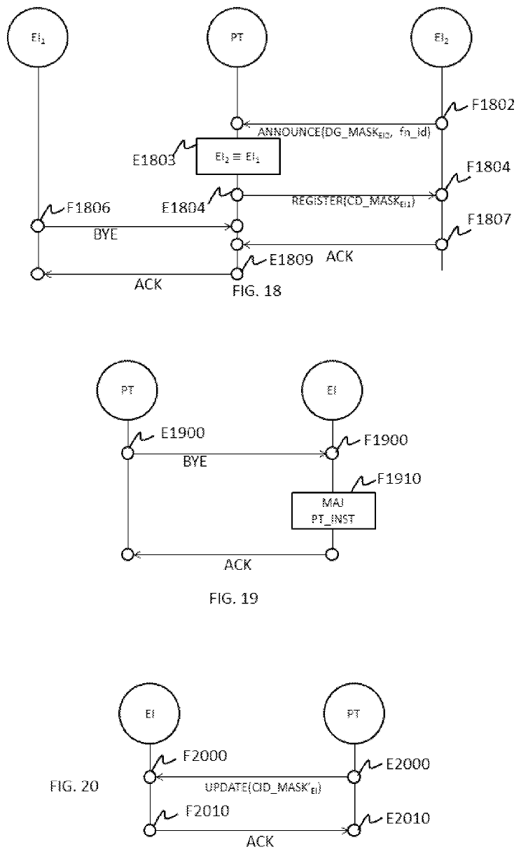

FIG. 19 shows in the form of a flow chart a process which can be implemented to withdraw a communication device PT. To do this, the communication device PT broadcasts (or sends via unicast mode) in a step E1900 a withdrawal message BYE to the intermediate entities EI concerned, i.e. associated with an active communication identifier mask as entered in the intermediate entity instance table EI_INST kept by the communication device.

An intermediate entity EI receives this withdrawal message BYE in a step F1900. In a step F1910, the intermediate entity EI updates the communication device instance table PT_INST, and more precisely the state associated with the active communication identifier mask CID_MASK_{EI} for the communication device PT. In the embodiment described here, the state is modified to take the on-but-terminating value OBT indicating that the mask is still active but will become inactive, for example after a given expiry period or after the termination of the last active communication set up between this intermediate entity and the communication device.

FIG. 20 shows a process of resetting of a communication identifier mask on the initiative of a communication device PT.

In a particular embodiment of the invention, a communication device PT can modify a communication identifier mask CID_MASK_{EI} by sending to an intermediate entity EI associated with an active communication identifier mask as entered in the instance table EI_INST kept by the communication device, in a step E2000, a mask modification message UPDATE to register with this entity a new mask CID_MASK_{EI}′ generated in application of the same instructions as CID_MASK_{EI} used by the communication device for this entity. The intermediate entity EI receives this message in a step F2000.

The mask modification message UPDATE includes the new mask CID_MASK_{EI}′ and where applicable an expiry period for the activation of this new mask. In the embodiment of the invention described here, this expiry period is optional and in the absence of any expiry period, the intermediate entity considers that the modification request must be handled immediately.

However, in the embodiment described here, even if the expiry is immediate, the intermediate entity EI does not immediately replace the old mask CID_MASK_{EI} with the new mask CID_MASK′_{EI} in its communication device instance table PT_INST.

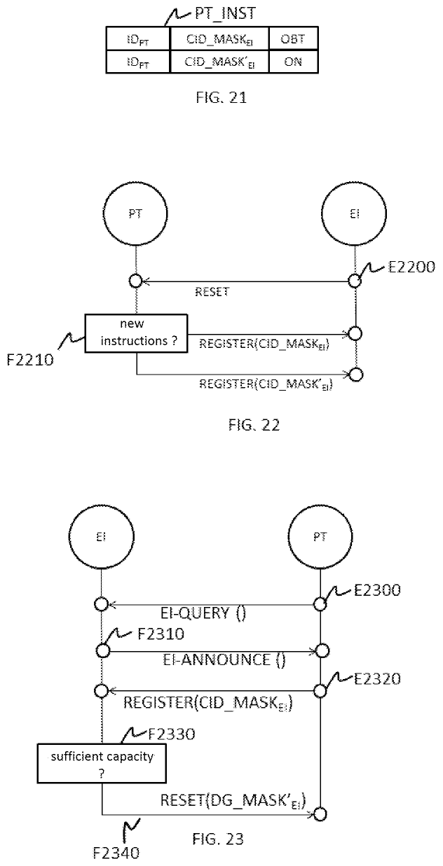

FIG. 21 illustrates the communication device instance table PT_INST managed by the intermediate entity EI after receiving the UPDATE message: the new mask is associated with a state “ON” and the old one with an on-but-terminating state “OBT”.

The intermediate entity EI sends an acknowledgment message to the communication device in a step F2010 to indicate to it that it has correctly received the mask modification message. When the communication device receives this acknowledgment of receipt (step E2010), it can start to use the new mask CDI_MASK′_{EI}.

These packets are handled by the intermediate entity, the state of this mask being active in the table PT_INST.

FIG. 22 shows in the form of a flow chart a process for resetting a communication identifier mask on the initiative of an intermediate entity.

In a particular embodiment of the invention, an intermediate entity EI can ask the communication devices to modify their communication identifier mask CID_MASK_{EI} by sending them a resetting message RESET, in a step E2200.

If this message does not contain an argument, the communication device PT registers (step F2210) a new mask CID_MASK′_{EI} with this entity EI, the latter being generated in application of the last instructions supplied by this entity.

If this message includes new instructions DG_MASK′_{EI}, the communication device PT registers these new instructions, generates a new mask CID_MASK′_{EI} in application of these new instructions and registers this new mask with the entity EI.

The mask resetting message RESET can include an expiry period for its activation. In the embodiment of the invention described here, this expiry is optional and in the absence of an expiry period, the intermediate entity considers that the reset request must be handled immediately.

If the reset message RESET includes new instructions DG_MASK′_{EI}, it is preferable to choose a long enough expiry period to avoid communication identifier conflicts.

As for the resetting of a mask on the initiative of the communication device previously described with reference to FIGS. 20 and 21, the intermediate entity EI does not immediately replace the old mask CID_MASK_{EI} with the new mask CID_MASK′_{EI} in its communication device instance table PT_INST: the new mask is associated with a state “ON” and the old one with an on-but-terminating state “OBT”.

FIG. 23 represents in the form of a flow chart a process which can be implemented to introduce a new communication device PT, for example a new service instance PT_{IS} to replace another service instance or increase the handling capacity of a service.

In the embodiment described here, when a new communication device PT is introduced, it sends, in a step E2300, a discovery message QUERY identical to that sent in step E0400 already described.

An intermediate entity EI answers it with an announcement message ANNOUNCE identical to that already described with reference to step F0410 (step F2310) and the communication device PT proceeds to register its communication identifier mask (step E2320).

In the embodiment described here, when the new communication device PT hosts a new service instance PT_{IS}, the intermediate entity EI checks, in a step F2330, whether or not the communication identifier mask generation instructions it supplies to the service instances declaring themselves to it to generate communication identifier masks (see steps F0410 or F1300) include enough bits to allow the service instances that are active with it and the new service instance to generate masks and thus allow it to handle the packets transmitted by or addressed to these different service instances.

During this step, the intermediate entity EI determines:
the number of active service instances by searching for those associated with a communication identifier mask in the state “ON” in its communication device instance table PT_INST; and
the number of n significant bits of its mask generation instructions DG_MASK_{EI}.

These items of information are enough to allow the intermediate entity EI to determine whether or not the instructions have enough significant bits to meet the needs of a new service instance, bearing in mind that the maximum theoretical number of service instances which can be served is 2ⁿ.

If such is not the case, the intermediate entity EI sends, in a step F2340, a resetting message RESET with new instructions DG_MASK′_{EI} including enough significant bits to ask the communication devices PT_{IS} concerned to generate a new mask CID_MASK_{EI} and to register it with this entity EI.

For example, if nb is the number of service instances that must be served by the intermediate entity, the number of significant bits of the new instructions DG_MASK′_{EI} can be chosen equal to:

(nb+1)/2 mod(2).

With reference to FIG. 11 it has been explained how the invention could, in a particular embodiment, be implemented by a traffic load balancing function. FIG. 24 illustrates a particular implementation of the invention wherein the intermediate entity is a firewall EI_{FW}, to improve the security level offered to communication devices, for example terminals PT_{UT1}, PT_{UT2} and PT_{UT3} protected by this firewall.

This embodiment of the invention can in particular be used to guard against known attacks referred to as “connection injection” attacks, in which, even in the presence of a firewall, an attacker SA successfully sends traffic transmitted with an IP address usurped from a legitimate communication device, for example an instance of PTTs.

In the embodiment described here, the intermediate entity EI_{FW} of firewall type can keep in its communication device instance table PT_INST:
communication identifier masks CID_MASK^{IN}_{EI} for controlling the incoming communications to a terminal PT_{UT};
and/or communication identifier masks CID_MASK_{OUTEI} for controlling the outgoing communications from a terminal PU_{UT}.

The table PT_INST can in particular contain two masks CID_MASK^{IN}_{EI} and CID_MASK^{OUT}_{EI} for controlling the incoming communications and the outgoing communications of one and the same terminal.

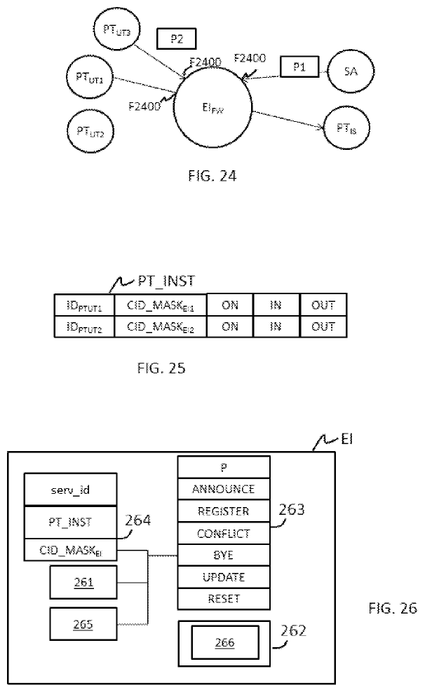

In the embodiment described here, and as shown in FIG. 25, the communication device table PT_INST includes an attribute IN/OUT used to determine whether or not a communication identifier mask associated with a terminal must be used to control the incoming or outgoing communications of this terminal. In the example of FIG. 26, one and the same mask is used to filter the incoming and outgoing communications of a communication device but the invention does not impose it.

In the example of FIG. 24, the firewall EI_{FW} obtains (step F2400) the communication identifier SCID, DCID conveyed in the packets exchanged between the terminals PT_{UT1}, PT_{UT2} and PT_{UT3} on the one hand and the service instance PT_{IS} on the other, to control the incoming and outgoing communications of the terminals PT_{UT1} and PT_{UT2}. The firewall is able to block:
a packet P1 sent to the terminal PT_{UT1} by a server SA that might have usurped the IP address assigned to the service instance PT_{IS} if the destination communication identifier DCID does not correspond to the CID_MASK_{EI1} negotiated between this terminal and the firewall EI_{FW}; and
a packet P2 sent by a terminal PT_{UT3} usurping the IP address assigned to the terminal PT_{UT1} if the source communication identifier SCID does not correspond to the mask negotiated between the terminal PT_{UT1} and the firewall EI_{FW}.

Several messages have been proposed in the different embodiment of the invention presented above, solely by way of illustration. One or more of these messages could be introduced into the QUIC protocol for the implementation of the invention. This concerns in particular:
the discovery message QUERY sent by the communication devices to discover intermediate entities;
the announcement message ANNOUNCE sent by the intermediate entities to announce their presence;
the registration message REGISTER used by a communication device to register a communication identifier mask with one or more intermediate entities;
the message CONFLICT used by the intermediate entities to report a conflict;
the message BYE sent by an intermediate entity or by a communication device to withdraw;
the message UPDATE sent by a communication device PT to modify a communication identifier mask;
the message RESET sent by an intermediate entity to ask the communication devices to modify their communication identifier mask.

FIG. 26 shows the hardware architecture of an intermediate entity EI in accordance with a particular embodiment of the invention. In this particular embodiment, this intermediate entity has the hardware architecture of a computer. It includes a processor 261, a read-only memory of ROM type 262, a random-access memory 263 and a rewritable non-volatile memory 264, and communicating means 265.

The read-only memory 262 includes a computer program 266 including instructions which, when they are executed by the processor 261, implement a method for managing communications in accordance with the invention and in particular the steps FXX previously described.

The rewritable non-volatile memory 264 particularly includes:
the identifiers serv_id of the services that can be handled by the function of the intermediate entity EI;
one or more mask generation instructions DG_MASK_{EI};
a communication device instance table PT_INST of the type shown in FIG. 8;

The packets P and the different messages recalled above are stored in the random-access memory 263 while they are handled by the processor 261.

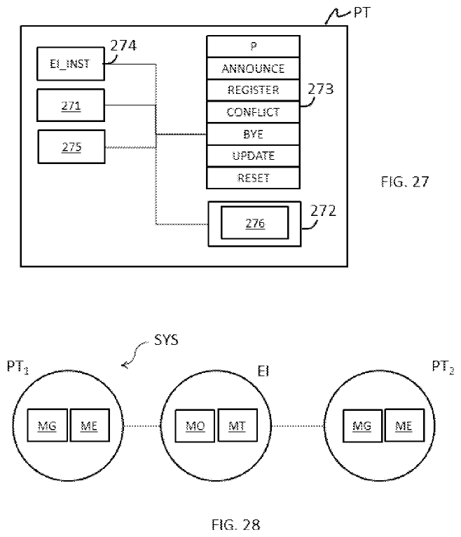

FIG. 27 shows the hardware architecture of a communication device PT in accordance with a particular embodiment of the invention. In this particular embodiment, this communication device has the hardware architecture of a computer. It includes a processor 271, a read-only memory of ROM type 272, a random-access memory 273, a rewritable non-volatile memory 274, and communicating means 275.

The read-only memory 272 includes a computer program 276 including instructions which, when they are executed by the processor 271, implement a method for managing communications in accordance with the invention and in particular the steps EXX previously described.

The rewritable non-volatile memory 274 particularly includes:
an intermediate entity instance table EI_INST of the type of that shown in FIG. 6.

The packets P and the different messages recalled above are stored in the random-access memory 273 while they are handled by the processor 271.

In the embodiment described here, the communicating means 265 and 275 are configured to communicate according to the QUIC protocol. The communicating means 265 of the intermediate entity are configured to intercept the packets P compliant with the QUIC protocol exchanged by the communicating means 275 of communication devices PT. These communicating means are also configured to be able to send or receive the messages recalled above.

FIG. 28 shows a system SYS in accordance with a particular embodiment of the invention. This system includes two communication devices PT₁, PT₂ and an intermediate entity EI in accordance with a particular embodiment of the invention, the intermediate entity being placed on a path used to set up communications between these communication devices.

This FIG. 28 shows the functional architecture of the intermediate entity EI and the functional architecture of the communication devices PT₁ and PT₂.

The intermediate entity EI includes:
an obtaining module MO configured to obtain a communication identifier SCID, DCID conveyed in a packet exchanged during said communication;
a handling module MT configured to handle this packet as a function of a result of a check of the conformity of said communication identifier SCID, DCID according to at least one communication identifier mask CID_MASK_{EI} accessible by the intermediate entity EI.

These modules can be implemented by the hardware and software means of an intermediate entity shown in FIG. 26.

The communication device PT₁ includes:
a module MG for generating communication identifiers configured to generate at least one communication identifier intended to be used as communication identifier SCID, DCID in a communication set up between the communication device PT₁ and the communication device PT₂ in a communication network, this identifier conforming to at least one communication identifier mask CID_MASK_{EI} accessible to the intermediate entity EI; and
a module ME for sending packets, configured to send at least one data packet including this communication identifier SCID, DCID in the context of this communication.

These modules may be implemented by the hardware and software means of a communication device shown in FIG. 26.

1. A method for managing a communication between at least a first communication device and at least a second communication device in a communication network, said method being implemented by an intermediate entity located on at least one path taken by data packets of said communication, said method including:
obtaining a communication identifier conveyed in a data packet exchanged during said communication; and
handling said data packet as a function of a result of a check of the conformity of said communication identifier to at least one communication identifier mask accessible by said intermediate entity.

2. The method of claim 1, wherein
said communication identifier mask is received from one of said first and second communication devices and associated by said intermediate entity with said one of said first and second communication devices;
said handling of said data packet being moreover determined as a function of said one of said first and second communication devices associated with said mask.

3. The method of claim 2, further comprising:
sending an announcement message including at least one communication identifier mask generation instruction;
said communication identifier mask being received from said one of said first and second communication devices in response to said announcement message.

4. The method of claim 3, wherein
said intermediate entity offers a given function, the method further comprising:
receiving, from at least one of said first and second communication devices, at least one communication identifier mask generated by said at least one of said first and second communication devices on the basis of at least one communication identifier mask generation instruction supplied by another intermediate entity offering said given function.

5. The method of claim 3, wherein said announcement message includes an identifier of a service which identifies a service, data packets of which can be handled by said intermediate entity.

6. The method of claim 2, further comprising:
a step of detecting conflicts, a conflict being detected if said communication identifier mask received from a communication device constituting an instance of a service has already been associated by said intermediate entity with at least one other communication device constituting a different instance of the same service; and
a step of triggering a modification of said communication identifier mask by at least one of these communication devices.

7. The method of claim 2, wherein said intermediate entity implements a traffic load balancing function, said handling of said data packet including conveying said data packet to a said communication device associated with a communication identifier mask to which said communication identifier conforms, and a traffic load balancing algorithm.

8. The method of claim 1, wherein said intermediate entity implements a firewall function, said handling of said data packet including the filtering of said packet as a function of the conformity or otherwise of said communication identifier to said at least one communication identifier mask.

9. The method of claim 3, further comprising:
checking whether or not said intermediate entity can serve said communication device as a function of:
(i) a number of communication devices already registered by said intermediate entity in association with a communication identifier mask generated in application of said at least one mask generation instruction; and
(ii) a number of bits defined by said at least one instruction; and
upon determining that said intermediate entity cannot serve said communication device, sending a reset message with at least one new instruction defining a greater number of bits, said reset message asking said communication device and said communication devices already registered to generate a new mask in application of said at least one new instruction.

10. A communication method implemented by a first communication device in a communication network, said method including:
generating at least one identifier intended to be used as communication identifier in a communication between said first communication device and at least a second communication device, said identifier conforming to at least one communication identifier mask accessible by at least one intermediate entity located on at least one path taken by data packets of said communication; and
of sending at least one data packet including said identifier in the context of said communication.

11. The method of claim 10, wherein said first communication device uses said communication identifier as a source communication identifier in said data packet.

12. The method of claim 10, wherein said first communication device sends said communication identifier encrypted in said data packet to said second communication device so that said second communication device uses said identifier as a destination communication identifier in a subsequent data packet of the communication.

13. The method of claim 10, further comprising:
generating at least one communication identifier mask by applying at least one communication identifier mask generation instruction; and
a step of registering said mask with said intermediate entity.

14. The method of claim 13, wherein said first communication device:
determines that said intermediate entity offers the same function as another intermediate entity; and
registers with said intermediate entity a communication identifier mask in application of said at least one mask generation instruction used for this other intermediate entity.

15. The method of claim 13, wherein said first communication device:
checks, before registering for a given service, a mask generated in application of said at least one instruction, with said intermediate entity, that it has not already registered, with another intermediate entity, a mask for the same service and generated by applying at least a second instruction different from said at least one instruction; and
upon determining that the first communication device has already registered a mask for the same service with another intermediate entity, registers with the intermediate entity a mask generated in application of said at least a second instruction.

16. The method of claim 3, wherein said at least one communication identifier mask generation instruction includes at least one item of information from among:
an item of information representative of a position of a first bit of a communication identifier corresponding to a mask of this identifier;
an item of information representative of a position of a last bit of said communication identifier corresponding to said mask; and
an item of information representative of the positions or of a number of bits of this communication identifier corresponding to said mask.

17. An intermediate entity configured to be placed on at least one path taken by data packets of a communication between at least a first communication device and at least a second communication device in a communication network, said intermediate entity including:
an obtaining module configured to obtain a communication identifier conveyed in a data packet exchanged during said communication; and
a handling module configured to handle said data packet as a function of a result of a check of the conformity of said communication identifier to at least one communication identifier mask (CID_MASK_{EI}) accessible by said intermediate entity (EI).

18. A communication device including:
a module for generating communication identifiers configured to generate at least one identifier intended to be used as a communication identifier, in a communication between said communication device and at least a second communication device in a communication network, said identifier conforming to at least one communication identifier mask accessible by at least one intermediate entity placed on at least one path taken by data packets of said communication; and
a sending module configured to send at least one data packet including said identifier as part of said communication.

19. A communication system including at least:
a communication device, said communication device being configured to communicate with at least a second communication device the communication device including:
a module for generating communication identifiers configured to generate at least one identifier intended to be used as a communication identifier in a communication between said communication device and said at least a second communication device in a communication network, said identifier conforming to at least one communication identifier mask accessible by at least one intermediate entity placed on at least one path taken by data packets of said communication; and
a sending module configured to send at least one data packet including said identifier as part of said communication; and
the intermediate entity (EI) of claim 17, configured to be placed on at least one path taken by data packets of a communication set up between said communication devices.

20. The method of claim 1, wherein said communication between said at least a first communication device and said at least a second communication device is set up according to the QUIC protocol.
